(19) United States
(12) Patent Application Publication
(10) Pub. No.: US 2014/0344354 A1
(43) Pub. Date: Nov. 20, 2014

(54) System and Method for Online Competitions

(71) Applicant: Seth Herman, West Palm Beach, FL (US)

(72) Inventor: Seth Herman, West Palm Beach, FL (US)

(21) Appl. No.: 13/897,103

(22) Filed: May 17, 2013

(51) Int. Cl. H04L 29/06

(52) U.S. Cl. CPC H04L 65/403
USPC 709/204

(57) ABSTRACT

A system and method for creating a competition on a website where a user can submit media material such as a photo, video or audio recording and other users can vote on the material. As negative votes arrive at the server, the user-submitted media material or an image representing it is caused to degrade. On type of degradation is to represent the material as a window pane that begins to crack as negative votes arrive. The cracking can get worse going from minor to moderate to major to heavy. Finally, with enough negative votes, the image can be destroyed. As positive votes arrive, degradation can be repaired and enhanced features added to, or associated with, images.

### BACKGROUND

### 1. Field of the Invention

The present invention relates generally to systems that provide online websites that allow the display of images and more particularly to a system and method for online competitions around these images.

2. Description of the Prior Art

It is known in the art to provide websites that allow the uploading and downloading of images such as photos and amateur video. Several of these sites are very well-known and used by millions of subscribers. While these sites allow the storage of photos and videos, they do not give any real way of allowing different users to compete.

Systems that allow users to compete are also known in the art. These many times concern singing or dancing or are related to music in some way; however, they are open to all categories including photos and amateur video. It would be advantageous to have a system and method that would allow users or subscribers to load amateur video or photos, and then allow them to start competitions. Competitions could be by category of subject matter such as singers, sports, dancers, funniest video, magicians, cars, rappers, looks of participants, animals, pranks and jokes, and any other category imaginable. Users could create their own competitions and invite their own judges.

### SUMMARY OF THE INVENTION

The present invention relates to a system and method that allows users or subscribers to load videos and/or photos onto a website for viewing by others, but also allows competitions and voting concerning the downloaded material.

The present invention allows a user to create a competition at will typically using a three-step process. The user first names the competition and specifies the video or other images to be in the competition. Next beginning and ending dates can be specified as well as the radius or group of other users involved in the competition. Finally judges can be named and the competition started. Specified users, or all users, can be asked to vote on the entry. Currently known video competitions do not allow users to create their own competitions or invite their own judges.

When users vote under the present invention, they can use various devices such as “Like”, “Dislike”, “Fist Bump”, and “Smash”. The last two indicate a very good response or very bad response. A large number of “Fist Bumps” can cause the video to receive a featured review or other prizes, while smashes can cause the video to be destroyed in entertaining and random ways, with really bad videos going to “the hall of shame”. For example, 0-25 smashes can show a screen with slight cracks visible; 25-50 smashes can show the screen with major cracks forming; 51-75 smashes can show the screen with heavy cracking; and over 75 smashes can cause substantial to heavy cracking of the screen leading to complete destruction of the screen image at around 100 smashes or other negative votes.

Any voting that visually affects the state of the submitted video or image is within the scope of the present invention. In particular, any voting keywords, clicks, or any other voting method can cause any kind of change in the image or video. In addition to degrading the image, some voting may enhance the image or cause borders to appear around the image or words on the image showing approval. The photo or video can be affected by a text or phone call from a user or directly accessing the platform by mobile or desktop device. Any method or technique known now or in the future affecting a photo or video is within the scope of the present invention. For example, the interaction can be via virtual reality interaction, virtual motion gesturing or tapping on a touch screen, as well as any other technique including simply calling in a vote by telephone.

The present invention can be used with any type of computers, servers or processors including desktops, laptops, tablets, telephones, game-controllers, and other mobile or desktop devices.

### DESCRIPTION OF THE FIGURES

Several figures and drawings are now presented to illustrate features of the present invention.

FIG. 1 shows a home page screen for a competition website.

FIG. 2 shows voting for a particular competition.

FIG. 3 describes a first bump.

FIG. 4 describes a smash.

FIG. 5 shows smash voting.

FIG. 6 shows slight cracking of a smash image.

FIG. 7 shows more cracking.

FIG. 8 shows heavy cracking.

FIG. 9 shows substantial cracking.

Several drawings and illustrations have been presented to aid in understanding the present invention. The scope of the present invention is not limited to what is shown in the figures.

### DESCRIPTION OF THE PREFERRED EMBODIMENTS

The present invention allows a user to create a competition at will using a three-step process. The user first names the competition and specifies the video or other images or other media to be in the competition. Next beginning and ending dates can be specified as well as the radius or group of other users involved in the competition. Finally judges can be named and the competition started. Specified users can be asked to vote on the entry.

The competition is hosted on a website where a user can submit the media material such as a photo, video or audio recording and other users can vote on the material. As negative votes arrive at the server, the user-submitted media material or an image representing it is caused to degrade. On type of degradation is to represent the material as a window pane that begins to crack as negative votes arrive. The cracking can get worse going from minor to moderate to major to heavy. Finally, with enough negative votes, the image can be destroyed.

When users vote under the present invention, they can use various devices such as “Like”, “Dislike”, “Fist Bump”, and “Smash”. The last two indicate a very good response or very bad response. A large number of “Fist Bumps” can cause the video to be receive a featured review or other prizes, while smashes can cause the video to be destroyed in entertaining and random ways, with really bad videos going to “the hall of shame”. For example, 0-25 smashes (or other predetermined number) can show a screen with slight cracks visible; 25-50 smashes can show the screen with major cracks forming; 51-75 smashes can show the screen with heavy cracking; and over 75 smashes can cause substantial to heavy cracking of the screen leading to complete destruction of the screen image with enough negative votes.

As previously stated, any voting that visually affects the state of the submitted video or image is within the scope of the present invention. In particular, any voting keywords, clicks, or any other voting method can cause any kind of change in the image or video. In addition to degrading the image, some voting may enhance the image or cause borders to appear around the image or words on the image showing approval. The photo or video can be affected by a text or phone call from a user or directly accessing the platform by mobile or desktop device. Any method or technique known now or in the future affecting a photo or video is within the scope of the present invention. For example, the interaction can be via virtual reality interaction, virtual motion gesturing or tapping on a touch screen, as well as any other technique.

As an example of enhancement, 100 first bumps can get the submitter a featured video review, put them in running for top video and all-time leader prizes, unlock special interactive features and get automatic posting on other social media sites. As an example of degradation, 100 smashes gets the video destroyed in entertaining and random ways as previously described. Smashed videos can be put in a “hall of shame” category where other users can watch them and see how they were killed. Worst smash videos can win a prize. A smash is a way for people to show their disapproval for a video and can result in −5 points (or other number). Users can have a limited number of smashes to use on the site and can earn more through game play. These numbers and processes for enhancement and degradation are for example only. Any enhancement or degradation of a media file like a video or photo is within the scope of the present invention.

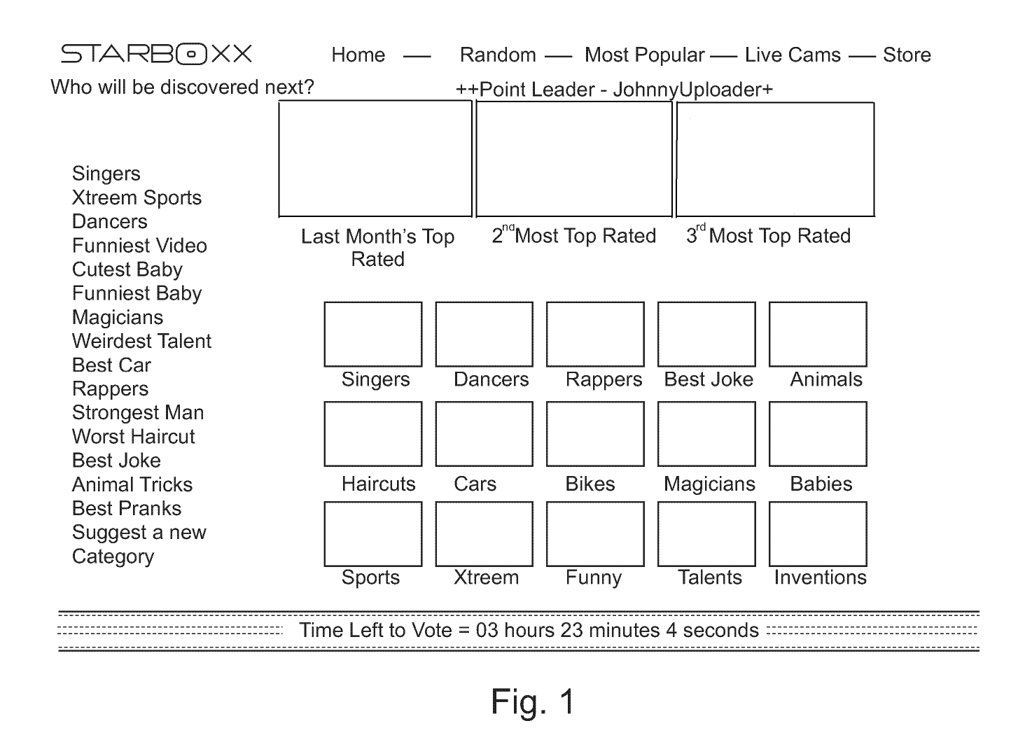

Turning to FIG. 1, an example home page for a competition website can be seen. Here items like last month's top rated videos can be seen as well as button choices to different categories of talent or videos. In this example (and the categories in FIG. 1 are simply examples of many different possible categories), it is possible to choose between singers, dancers, rappers, jokes, animals, haircuts, cars, bikes, magicians, babies, sports, xtreem video, funny, talent, inventions and any other possible category. In fact, there can be a button to suggest a new category.

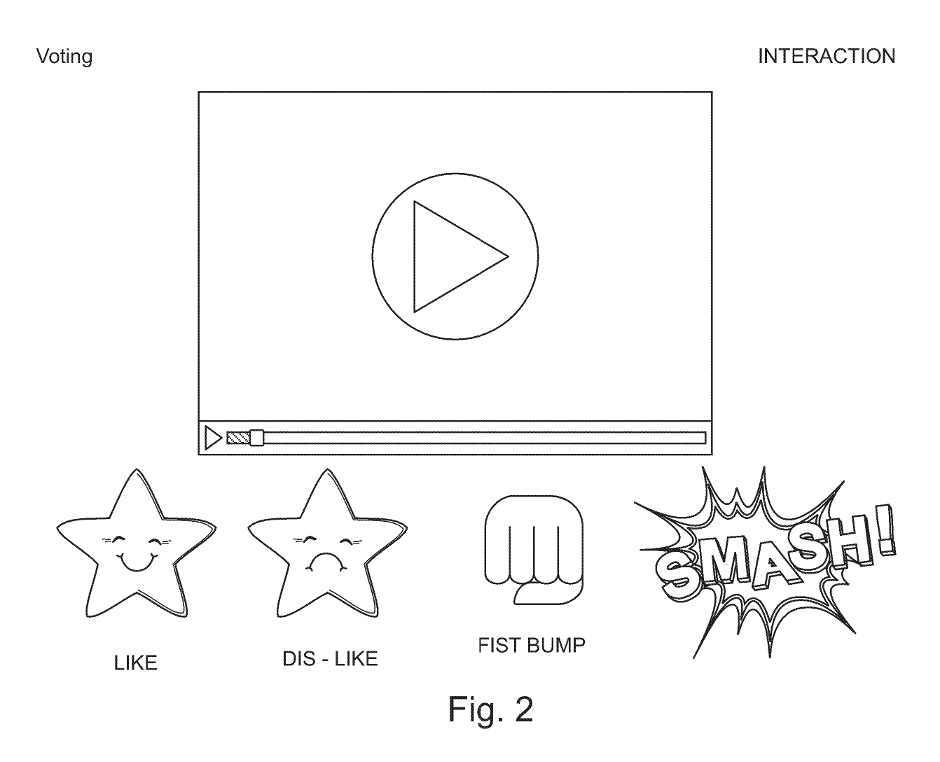

A key feature of the present invention is the ability for a user to start a competition, and optionally name judges, and the ability to have other users vote. Any user of the present invention can start a competition simply by entering their ID, specifying what video they want to compete with, choosing who can vote, and then kicking off the competition. Any user that can vote in a particular competition can vote as shown in FIG. 2, namely play the video and then hit “Like”, “Dislike”, “Fist Bump” or “Smash”. Like and dislike are simple votes that are tallied with votes of others. A first Bump indicates a great liking and can be used to significantly raise the score in a particular competition. A Smash has the opposite effect. It can lower the score or count against the competitor. In addition, when a competitor receives a certain number of Smashes, they can see their video destroyed in an entertaining and random manner.

An optional feature of the invention is a “Save” icon or button on the page where a user can save another user's video from being smashed. Through game play, users can earn additional “Saves” and even donate “Saves” to other users. This process can also be implemented for “Fist Bumps”, and “Smashes” or any other voting choices.

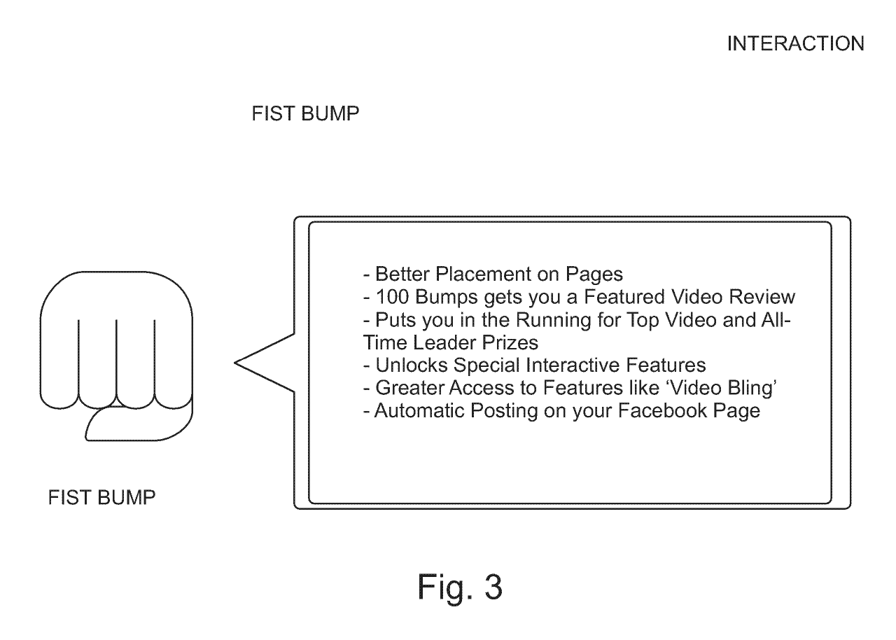

A “Fist Bump” can have the following rewards as shown in FIG. 3: better placement on pages, 100 bumps can a featured video review, a lot of bumps can put the video in running for top video awards, bumps unlock special interactive features, and automatic posting on other websites.

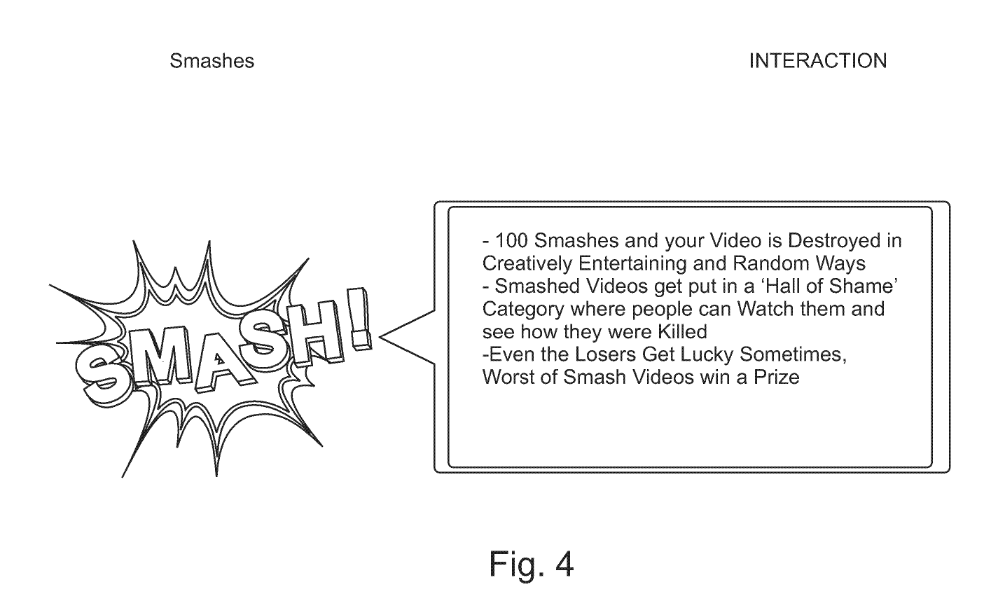

A particular way of destroying the video under a smash is by showing a simulated glass screen that cracks more and more as more and more smashes come in. For example, as shown in FIG. 4, 100 smashes and your video becomes totally destroyed in a creative and entertaining way. Smashed videos can be put in a “Hall of Shame” or other punishment. Users can watch smashed videos and see how they were killed. Sometimes, even losers get lucky where the worst of the smashed videos can win a prize. Any method of changing the submitted image is within the scope of the present invention.

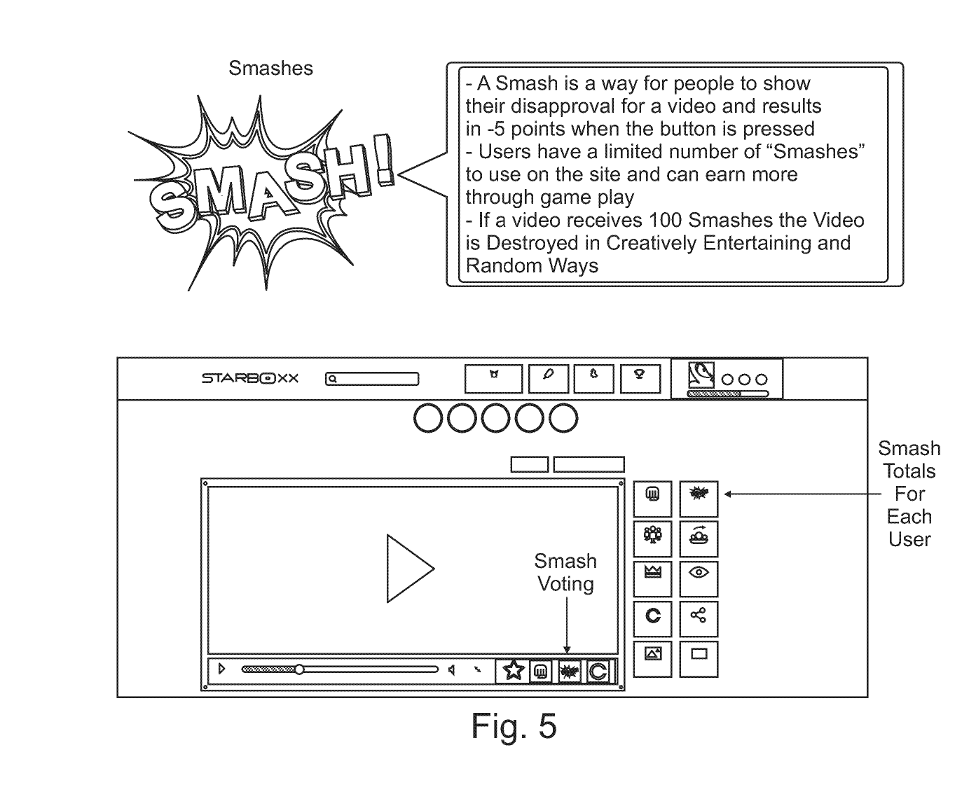

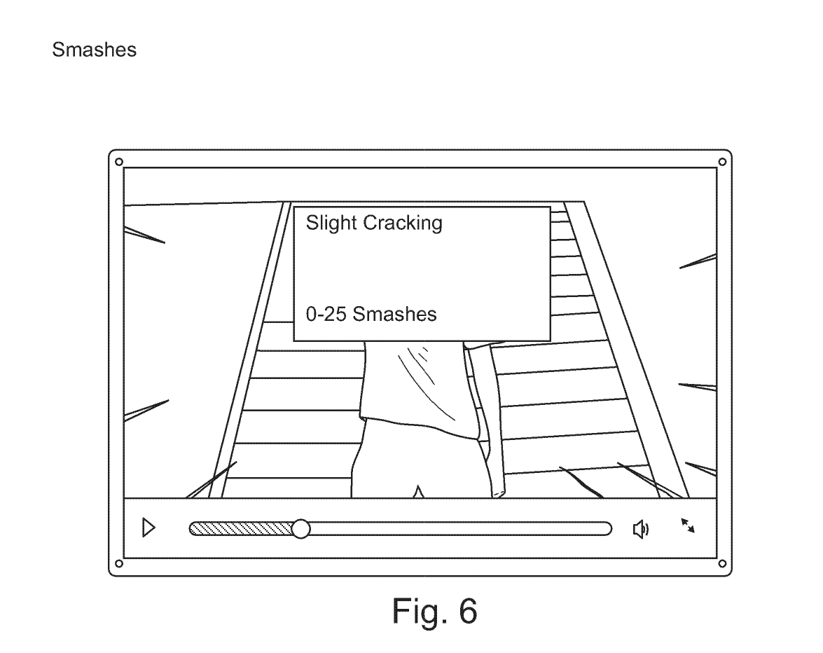

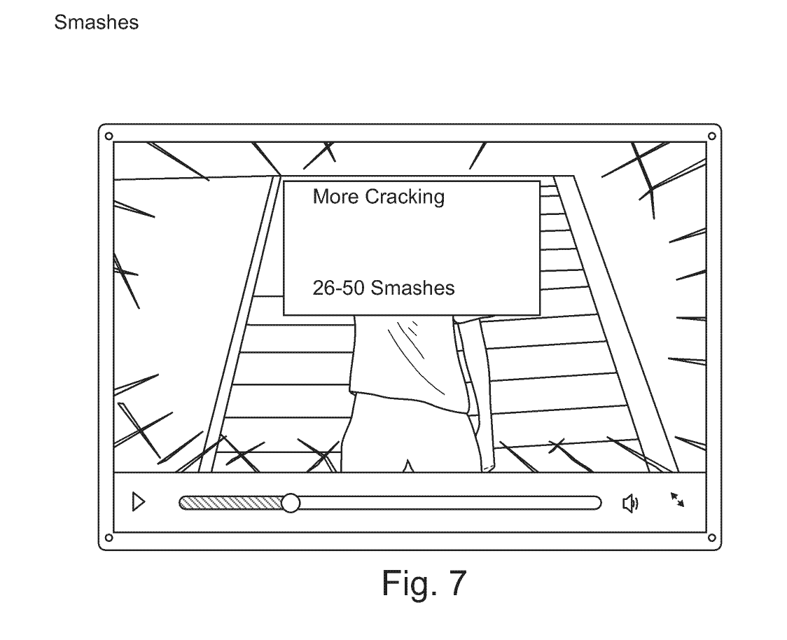

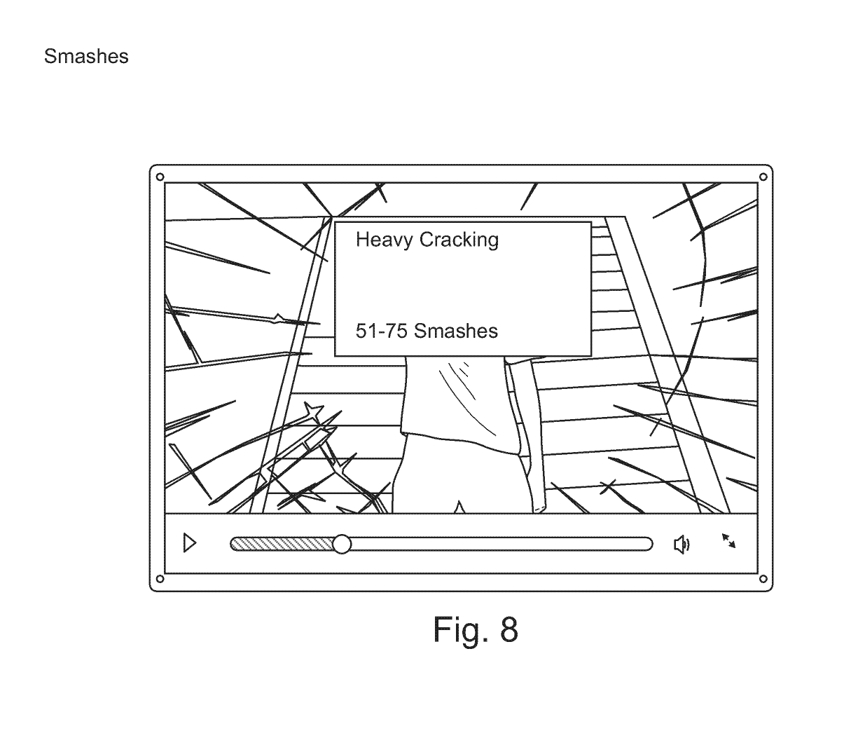

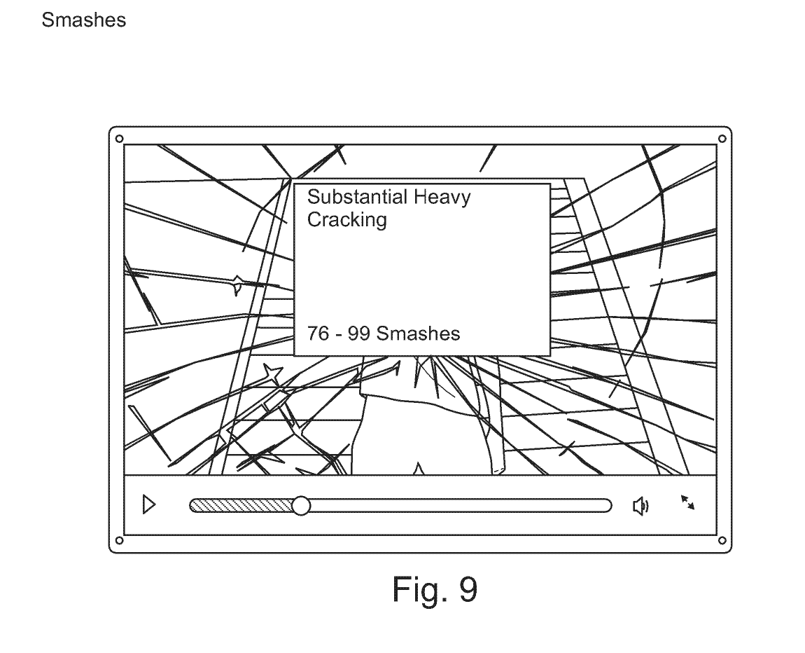

FIGS. 5-9 show how videos can be smashed. The image of a glass window can be used which is subsequently cracked more and more as more smashes come in. FIG. 6 shows 0-25 smashes with slight cracking. FIG. 7 shows 26-50 smashes with more cracking. FIG. 8 shows 51-75 smashes with heavy cracking, and FIG. 9 shows over 75 smashes with very heavy cracking. Over 100 smashes can optionally result in complete disintegration of the glass. The numbers 25, 50, 75 and 100 are for example only. Any first, second, third and/or fourth predetermined numbers may be used as thresholds for various types of image degradation. In addition, continuous degradation of the image can be used.

It is apparent under the present invention that any visual device besides just the image of a window can be used and smashed. Any type of degradation or enhancement of an image based on the number of incoming or recorded votes is within the scope of the present invention.

One embodiment of the present invention is to have the server maintain a total vote count score. This number can equal the number of positive votes minus the number of negative votes. When this number is negative, the image representing the user-submitted video or photo can begin to degrade. When the number is positive, the image can stay the same or, after some count of positive votes, receive a laudatory comment or a decorative border. Degrading can be cracking or by any other technique. In particular, cracking can be applied when the image representing the photo or video is made to look like a window pane. It should be understood that the image representing the photo or video can be the photo itself (in the case of a photo), or it can be a frame of a video, or it can be any other likeness or representation of the user-submitted material. Enhancement can include repairing cracks or degradation, adding special borders, placing the image on more prominent display or on a page containing winners or best images or by any other method of enhancement including awarding points and bonuses to the image's owner.

Degradation or enhancement can take place in real-time as votes come in, or incrementally, or even after the total voting is complete.

The competition website will typically reside on a server. This server will have a processor connected to several memory devices such as RAM, ROM, DRAM, disks and any other memory and storage devices. The server will also be connected to a network interface through a Network Interface Card or similar device. The network can be the Internet, an intranet, a WiFi network, a telephone network, or any other type or kind of network wired or wireless. The server processor will typically execute sets of stored computer instructions to display the web pages, images, photos and the like, to host competitions, to receive and count votes, and to cause images representing user-submitted material like photos or video to change in response to voting, in particular to degrade or even crack in response to negative voting as previously described.

Users can access the website or server over the network from any type of user device including desktop computers, laptops, tablets, telephones, smart-phones game controllers, or any other user device. Voting by users can take any form including clicking a button on a web page (like smash), tapping on a touch-sensitive screen, by gesturing into a camera, or by any other interface or method including calling in a vote by telephone.

Several descriptions and illustrations have been provided to aid in understanding the present invention. One with skill in the art will realize that numerous changes and variations may be made without departing from the spirit of the invention. All such changes or variations are within the scope of the present invention.

I claim:

1. A voting method for remote voting on a server hosting a webpage for a user-submitted video or photo over a computer network by a plurality of users having remote hardware devices, said server having a processor, memory and a network interface; the server executing a set of stored computer instructions, the method comprising:
receiving on said server the user-submitted video or photo over the network from a user having a first remote hardware device;
storing said video or photo in at least one memory device connected to said server;
generating on said server, an image representing said user-submitted video or photo;
displaying said image on the webpage, said image originating at the server and transmitted over the network to the plurality of remote user hardware devices;
receiving votes for said video or photo, said votes transmitted by signals over a network from the remote user hardware devices to the server;
causing said image to progressively degrade on said webpage as negative votes arrive at the server.

2. The voting method of claim 1 including maintaining a total negative vote count.

3. The voting method of claim 1 further comprising representing said image in a simulated window pane on said webpage.

4. The voting method of claim 2 further comprising causing said image to display minor cracking when said total negative vote count is less than a first predetermined value, moderate cracking when said total negative vote count is equal to or greater than said first predetermined value and is less than a second predetermined value, major cracking when said total negative vote count is equal to or greater than said second predetermined value and is less than a third predetermined value, and causing said image to be destroyed when said total negative vote count is greater than a fourth predetermined value.

5. The voting method of claim 3 further comprising causing said image to display minor cracking when said total negative vote count is less than a first predetermined value, moderate cracking when said total negative vote count is equal to or greater than said first predetermined value and is less than a second predetermined value, major cracking when said total negative vote count is equal to or greater than said second predetermined value and is less than a third predetermined value, and causing said image to be destroyed when said total negative vote count is greater than a fourth predetermined value.

6. The voting method of claim 4 wherein said first predetermined value is 25; the second predetermined value is 50; the third predetermined value is 75; and the fourth predetermined value is 100.

7. The voting method of claim 5 wherein said first predetermined value is 25; the second predetermined value is 50; the third predetermined value is 75; and the fourth predetermined value is 100.

8. The voting method of claim 1 further comprising maintaining a positive status for said image and enhancing said positive status as positive votes arrive at the server.

9. A voting system for remote voting for a user-submitted image over a computer network between a remote user hardware device and a remote server comprising:
a set of executable stored instructions adapted to execute on a server processor that receive and store a video or photo submitted over said computer network from a first user hardware device to the server, said server processor coupled to a plurality of memory devices and to a network interface,
said stored instructions adapted to display an image representing said video or photo over the network to a plurality of other users, said plurality of other users each accessing said server from other remote user hardware devices;
said stored instructions adapted to receive and count positive and negative votes concerning said photo or video from said plurality of other users;
said stored instructions also adapted to cause said image representing said video or photo to change in response to incoming votes as votes concerning said photo or video arrive at said server.

10. The system of claim 9 wherein said stored instructions cause said image to progressively degrade when more negative votes arrive than positive votes.

11. The system of claim 9 wherein said stored instructions cause said image to progressively crack when more negative votes arrive than positive votes.

12. The system of claim 11 wherein said stored instructions cause said image to show minor cracking when negative votes exceed a first predetermined number; moderate cracking when negative votes are equal or greater to said first predetermined number and less than a second predetermined number; heavy cracking when negative votes are equal or greater to said second predetermined number and less than a third predetermined number; major cracking when negative votes are equal or greater to said third predetermined number and less than a fourth predetermined number; and wherein said stored instructions cause destruction of said image when negative votes exceed said fourth predetermined number.

13. The system of claim 12 wherein the first predetermined number is 25, the second predetermined number is 50, the third predetermined number is 75 and the fourth predetermined number is 100.

14. A set of computer instructions adapted to execute on a server processor to produce and display a plurality of web pages supplied to remote users over a network, the server processor being of the type with connected memory, storage devices, and a network interface, the server processor receiving, storing and displaying on at least one web page a user-submitted photo or video, the server also receiving over the network positive and negative votes from users concerning said user-submitted photo or video, the invention comprising:
a subset of said computer instructions that cause a representation of said user-submitted photo or video to be displayed over the network on at least one of said web pages, said subset of computer instructions causing said representation to degrade as negative votes arrive from users over the network.

15. The set of computer instructions of claim 14 wherein said subset of computer instructions cause cracking in said representation as negative votes arrive from said users over the network.

16. The set of computer instructions of claim 15 wherein said subset of computer instructions cause said cracking to become worse as more and more negative votes arrive from said users over the network.

17. The set of computer instructions of claim 16 wherein said subset of computer instructions cause said representation to be destroyed after a predetermined number of negative votes arrive from said users over the network.

18. The set of computer instructions of claim 14 wherein said subset of computer instructions cause said representation to be destroyed after a predetermined number of negative votes arrive from said users over the network.

19. The set of computer instructions of claim 15 wherein said subset of computer instructions causes minor cracking of said representation after a first predetermined number of negative votes arrive; moderate cracking of said representation after a second predetermined number of negative votes arrive; major cracking of said representation after a third predetermined number of negative votes arrive; and destruction of said representation after a fourth predetermined number of votes arrive; said second predetermined number greater than said first predetermined number; said third predetermined number greater than said second predetermined number, and said fourth predetermined number greater than said third predetermined number.

20. The set of computer instructions of claim 19 wherein said first predetermined number is 25; said second predetermined number is 50; said third predetermined number is 75; and said fourth predetermined number is 100.
